(19) United States
(12) Patent Application Publication
(10) Pub. No.: US 2015/0160373 A1
(43) Pub. Date: Jun. 11, 2015

(54) COMPUTER-IMPLEMENTED DATA ANALYSIS METHODS AND SYSTEMS FOR WIND ENERGY ASSESSMENTS

(71) Applicant: Cardinal Wind, Inc., Cambridge, MA (US)

(72) Inventors: Teasha Feldman-Fitzthum, Cambridge, MA (US); Una-May O'Reilly, Weston, MA (US); Alfredo Cuesta-Infante, Madrid (ES); Kalyan Veermachaneni, Brighton, MA (US)

(73) Assignee: Cardinal Wind, Inc., Cambridge, MA (US)

(21) Appl. No.: 14/563,418

(22) Filed: Dec. 8, 2014

Related U.S. Application Data
(60) Provisional application No. 61/913,261, filed on Dec. 7, 2013.

(51) Int. Cl. G01W 1/02

(52) U.S. Cl. CPC G01W 1/02

(57) ABSTRACT

Computer-implemented methods and systems are disclosed for performing wind resource assessments for potential wind farm sites using Gaussian copula correlation models.

### CROSS REFERENCE TO RELATED APPLICATION

This application claims priority from U.S. Provisional Patent Application No. 61913,261 filed on Dec. 7, 2013 entitled System and Method for Data Analysis for Wind Energy Assessments, which is hereby incorporated by reference.

### BACKGROUND

The present application relates generally to data analysis methods and systems for wind energy assessments used in selecting wind farm sites.

### BRIEF SUMMARY OF THE DISCLOSURE

In accordance with one or more embodiments, a computer-implemented method is provided for performing a wind resource assessment of a potential wind farm site. The method includes the steps of: (a) receiving wind condition data measured at the potential wind farm site over a given short term and wind condition data measured at a plurality of sites geographically proximal to the potential wind farm site over a given long term that includes the given short term; (b) synchronizing the wind condition data measured at the potential wind farm site with the wind condition data measured at the plurality of geographically proximal sites over the given short term to generate time-synchronized data sets; (c) building multivariate Gaussian copula correlation models between the time-synchronized data sets; and (d) using the multivariate Gaussian copula correlation models and the wind condition data measured at the plurality of geographically proximal sites over the given long term, excluding the given short term, to estimate long term wind conditions at the potential wind farm site, and expressing said estimated long term wind conditions as a set of probability distributions.

In accordance with one or more embodiments, a computer system comprises at least one processor, memory associated with the at least one processor, and a program supported in the memory for performing a wind resource assessment of a potential wind farm site. The program containing a plurality of instructions which, when executed by the at least one processor, cause the at least one processor to: (a) receive wind condition data measured at the potential wind farm site over a given short term and wind condition data measured at a plurality of sites geographically proximal to the potential wind farm site over a given long term that includes the given short term; (b) synchronize the wind condition data measured at the potential wind farm site with the wind condition data measured at the plurality of geographically proximal sites over the given short term to generate time-synchronized data sets; (c) build multivariate Gaussian copula correlation models between the time-synchronized data sets; and (d) use the multivariate Gaussian copula correlation models and the wind condition data measured at the plurality of geographically proximal sites over the given long term, excluding the given short term, to estimate long term wind conditions at the potential wind farm site, and express said estimated long term wind conditions as a set of probability distributions.

### BRIEF DESCRIPTION OF THE DRAWINGS

FIG. 1 is a graph illustrating an exemplary set of probability distributions of wind speed for a wind resource assessment in accordance with one or more embodiments.

FIG. 2 is an exemplary wind rose for a wind resource assessment in accordance with one or more embodiments.

FIG. 3 is a flow diagram illustrating an exemplary wind resource assessment process in accordance with one or more embodiments.

FIG. 4 is a simplified block diagram of an exemplary wind resource assessment system in accordance with one or more embodiments.

### DETAILED DESCRIPTION

Many factors influence selection of a wind farm site, including legal considerations, community opinion, ease of construction, maintenance, cabling cost and, importantly, whether there is enough wind in the ideal speed range that will endure over a long span of time such as, e.g., 20 years or longer. Various embodiments disclosed herein are directed to computer-implemented methods and systems for performing wind resource assessments to predict long term wind conditions at proposed wind farm sites.

Prediction of wind at high frequency like hours to days to weeks is fraught with technical and sensing challenges plus intrinsic uncertainty. Wind resource assessment for site selection contrasts with high frequency prediction. The goal of a wind resource assessment is to provide a general estimate that guides selection without being a precise prediction. The annual, actual wind resource of a farm would be expected to deviate from the assessment with reasonable variance. However, when the actual annual resource is averaged over a long time span, the assessment and the actual wind resource should ideally match up. In this way, wind resource assessment helps inform the question of the production capacity of the site over its extended lifetime (which potentially includes successive upgrades of turbines and related facilities).

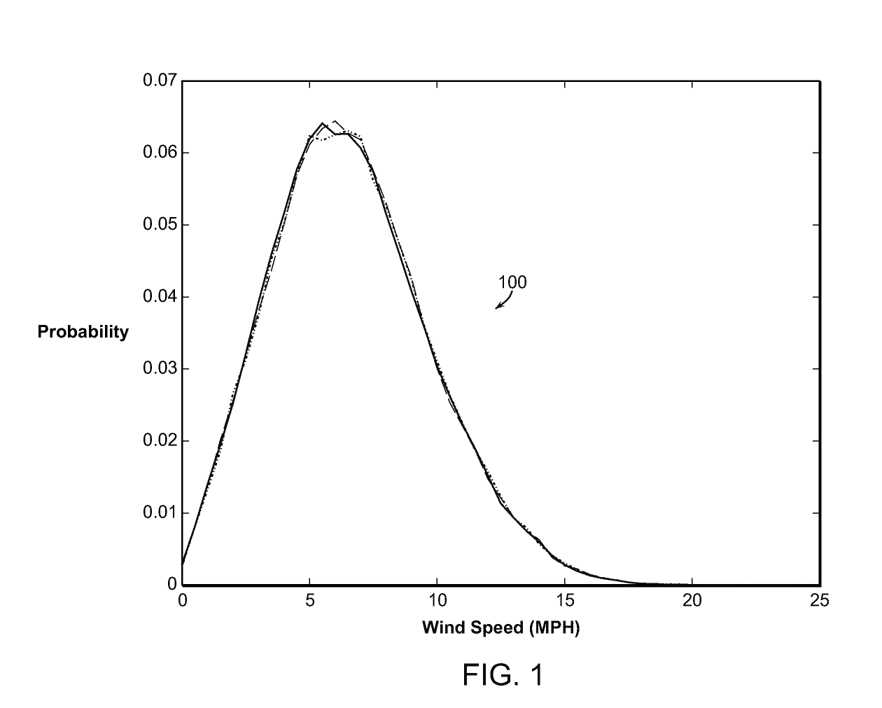

A wind resource assessment in accordance with one or more embodiments can be presented as a set of probability distributions of wind speed for directional intervals that span 360°. An exemplary set of three probability distributions 100, for the intervals 0°-15°, 15°-30°, and 30°-45° is shown in FIG. 1. Each plotted probability function may be optionally be modeled with a Weibull distribution, which is parameterized by shape and scale. Integrating this function (mathematically) allows one to derive the probability that the wind speed from a given direction range will be within a specific range.

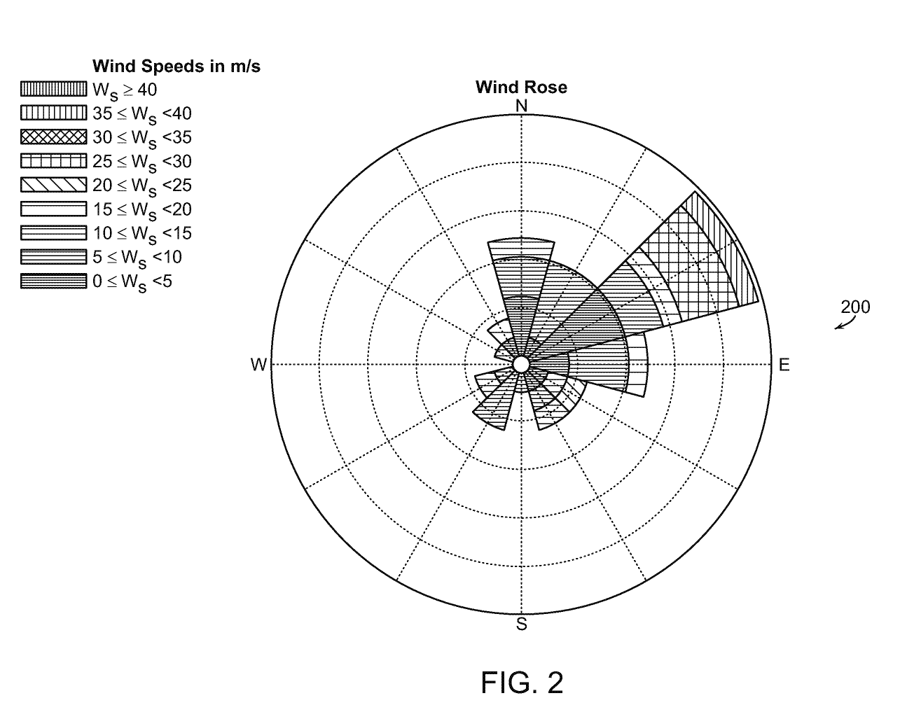

The assessment can also be visualized in other ways such as, e.g., as a wind rose 200 shown in FIG. 2. The span of the entire 360° is oriented in a North-South compass direction to inform its alignment to the site. FIG. 2 shows 12 direction intervals, each as a discrete “slice” with coloring that depicts wind speed. The length of the slice conveys probability.

Computer-implemented methods and systems for performing a wind resource assessment at a potential wind farm site in accordance with various embodiments utilize wind condition data measured at the potential wind farm site over a given short term (e.g., 3-60 months) and wind condition data measured at a plurality of sites geographically proximal to the potential wind farm site over a longer term (e.g., 1-20 years) that includes the given short term. By way of example, the geographically proximal sites providing the long term data may be 0-200 miles away from the potential wind farm site. The wind condition data for the geographically proximal sites may be obtained from various sources include, e.g., the Automated Surface Observing Systems (ASOS) and the Modern-Era Retrospective Analysis for Research and Applications (MERRA) databases.

The methods and systems for wind resource assessments disclosed herein seek to achieve highly accurate forecasts. This involves integrating multiple geographically proximal public wind data sources for improved accuracy. In some cases it is possible to concurrently reduce the duration of anemometer sensing at the potential wind farm site during the assessment period to reduce costs.

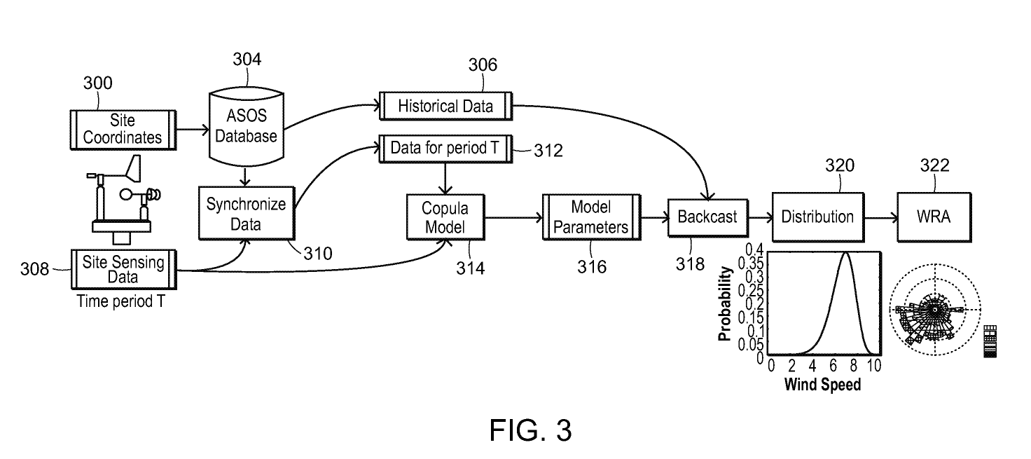

FIG. 3 is a flow diagram illustrating an exemplary wind resource assessment process in accordance with one or more embodiments. Site coordinates 300 of the potential wind farm site are input to one or more wind data sources, e.g., public online sources such as an ASOS database 304, to extract long term historical data 306 at neighboring sites. Site sensing data 308 measured at the potential wind farm site over a short term (time period T) are also obtained. Data munging is optionally performed on the site sensing data 308 and the historical data 306 for cleansing, filling in missing data points, etc.

The site sensing data 308 and the historical data 306 for the neighboring sites over the time period T are synchronized at 310 to obtain time-synchronized data sets 312.

Multivariate Gaussian copula correlation models 314 having model parameters 316 are built between the time-synchronized data sets for the period T.

Using the multivariate Gaussian copula correlation models and the historical data (excluding short term data for the time period T), long term wind conditions at the potential wind farm site are predicted at 318. The results are expressed in a probability distribution histogram 320 for the assessment 322. The probability distribution may, in some cases, be a Weibull distribution.

The service is automated, eliminating manual processing.

The wind resource assessment methods in accordance with one or more embodiments utilize Measure-Correlate-Predict (MCP) techniques as discussed below.

For notation, the wind at a particular location is characterized by speed denoted by x and direction Θ. The 360 degree direction is split into multiple bins with a lower limit (Θl) and upper limit (Θu). An index value of J=1 . . . j is given for the directional bin. The wind speed measurement at the proposed wind farm site is represented as y and the other sites (for which long term wind resource data is available) as x. These other sites are indexed with M=1 . . . m. The steps of MCP in accordance with one or more embodiments are as follows:

MEASURE: Short term sensing measurements at the proposed site and measurements at neighboring wind recording stations are collected and synchronized. Neighbor data for the past 10-20 years is reserved for backcast in the PREDICT step. Sensing measurements are denoted by Y={yₜ_{ₖ} . . . tₜ_{ₙ}}. Neighboring site measurements, also called historical data are denoted by X={xₜ_{ₖ} _{. . . y}_{ₙ}^{1 . . . m}}, where each xₜ_{ₖ} _{. . . t}_{ₙ}ⁱ corresponds to data from one historical site and m denotes the total number of historical sites.

CORRELATE: For each bin a directional model is built correlating the wind directions observed at the site with simultaneous neighboring site wind directions. Using likelihood parameter estimation, a multivariate distribution is built with the probability density function fx,y (x, y), where x={x₁ . . . xₘ} are the wind speeds at the historic sites and y is the wind speed at the site.

Next, for each directional bin, a model is trained using a multivariate Gaussian copula described below, correlating the wind speeds at the site with simultaneous speeds at the historical sites, i.e., Yₜ_{ᵢ}=f_{θ}_{ᵢ} (xₜ_{ᵢ}^{1 . . . m}) where k≦i≦n. Notationally, a model training point is referred to as 1 ∈ {1 . . . L} and a point for which a prediction is made as k ∈ {1 . . . K}. The notation is dropped for time after having time synchronized all the measurements across locations and the subscript for directional bin. Now when referring to a model, it is the model for a particular bin j. f_{Z}(z) refers to a probability density function of the variable (or set of variables) z. F_{Z}(z) refers to cumulative distribution function for the variable z such that F_{Z}(z=α)=∫_{—inf}^{α}f_{Z} (z) for a continuous density function.

Given the directional model, the probability density of y that corresponds to a given test sample xₖ={x₁_{ₖ} . . . xₘ_{ₖ}} is predicted by estimating the conditional density f_{Y} (y|xₖ). The conditional can be estimated by:

$${f}_{Y \vert X = {x}_{h}} ( y \vert {x}_{k} ) = \frac{{f}_{X , Y} ( {x}_{k} , y )}{{\int }_{y} {f}_{X , Y} ( {x}_{k} , y ) d y} . \qquad ( 1 )$$

PREDICT: To obtain an accurate estimation of long term wind conditions at the site, data from the historic sites (that is not simultaneous in time to the site observations used in modeling) is divided into subsets that correspond to directional bins. The model developed for that direction f_{θ}_{ᵢ} and the data from the historic sites corresponding to this direction xₜ_{₁} _{. . . t}_{ₖ}^{1 . . . m}−1|θⱼ are used to predict what the wind speed Y_{P}=yₜ_{₁} _{. . . t}_{ₖ}−1 at the site would be. A point prediction of ŷₖ is made finding the value for y that maximizes the conditional.

$$\hat{y} = {argmax}_{y ∈ Y} f ( y \vert X = {x}_{k} ) . \qquad ( 2 )$$

Then, with the predictions Yₚ, the parameters for a Weibull distribution expressing the mean and variance in speed are estimated. This is used for assessment of long term wind resource and the long term energy estimate. The bins' distributions comprise the assessment. The assessment, i.e., the statistical distribution in each bin, is then used to estimate the energy that can be expected from a wind turbine, given the power curve supplied by its manufacturer. This calculation can be extended over an entire farm if wake interactions among the turbines are taken into account.

Copula modeling is now described. The crux of the methodology is the joint density function of the model. A simple choice would be the multivariate Gaussian with Gaussian marginals. However conventionally the univariate densities f_{X}_{ᵢ} (xᵢ) are described with Weibull distributions. Copula theory neatly solves this problem. A copula function extracts the underlying joint behavior, which can be assumed to be multivariate Gaussian and allows individual behavior (parametric distributions) to be coupled with it as marginals. First, the individual parametric distributions are constructed. They are then coupled to form a multivariate density function. Finally, the value of y given x_{1 . . . m} is predicted. In detail:

A copula function C(u₁, . . . uₘ₊₁; Θ) with parameter Θ represents a joint distribution function for multiple uniform random variables U₁ . . . Uₘ₊₁ such that

C(u₁ , . . . uₘ₊₁; θ)=F(U₁≦u₁, . . . , Uₘ₊₁≦uₘ₊₁). (3)

Let U₁ . . . Uₘ represent the cumulative distribution functions (CDF) for variables x₁, . . . xₘ and Uₘ₊₁ represent the CDF for y. Hence the copula represents the joint distribution function of C(F(x₁) . . . F(xₘ), F(y)), where Uᵢ=F(xᵢ). According to Sklar's theorem, any copula function taking marginal distributions F(xᵢ) as its arguments defines a valid joint distribution with marginals F(xᵢ). Thus the joint distribution function for x₁ . . . xₘ, y can be constructed given by

F (x₁ . . . xₘy)=C (F(x₁) . . . F(xₘ), F(y); θ) (4)

The joint probability density function (PDF) is obtained by taking the m+1^{th} order derivative of the eq. (4), leading to the Sklar's theorem formulation for densities:

f (x₁ . . . x_{m,}y)=Πᵢ₌₁^{m} f(xᵢ) f(y) c(F(x₁) . . . F(xₘ), F(y)). (5)

where c(.) is the copula density. Thus the joint density function is a weighted version of independent density functions, where the weight is derived via copula density. In order to satisfy the assumption of an underlying multivariate Gaussian dependence structure, the Gaussian copula can be used given by

C_{G} (Σ)=F_{G}(F⁻¹ (u₁) . . . F⁻¹ (uₘ), F⁻¹ (u_{y}), Σ) (6)

where F_{G} is the CDF of multivariate normal with zero mean vector and Σ as covariance and F⁻¹ is the inverse of the standard normal.

There are two sets of parameters to estimate. The first set of parameters for the multivariate Gaussian copula is Σ. The second set, denoted by Ψ={ψ, ψ_{y}} are the parameters for the marginals of x, y. Given N i.i.d observations of the variables x, y, the log-likelihood function is:

L(x, y; Σ, Ψ)=Σₜ₌₁^{N} log f(xₗ, yₗ|Σ, Ψ)=Σₗ₌₁ log {(Πᵢ₌₁^{m} f(xᵢₗ; ψᵢ) f (yₗ; ψ_{y})) c (F(x₁) . . . F(xₘ), F(y); Σ)}

Parameters are estimated, via:

$$\hat{Ψ} = {argmax}_{Ψ ∈ ψ} \{ {\sum }_{l = 1}^{N} log \{ \begin{matrix}( {\sum }_{i = 1}^{m} f ( {x}_{il} ; {ψ}_{i} ) f ( {y}_{l} ; {ψ}_{y} ) ) \\ c ( F ( {x}_{1} ) … F ( {x}_{m} ) , F ( y ) ; \sum )\end{matrix} \} \} \qquad ( 7 )$$

A variety of algorithms are available in literature to estimate the MLE in eq. (7). To obtain predictions from a copula, for a new observation x, the conditional is formed first by

$$P ( y \vert x ) - \frac{P ( x , y )}{{\int }_{y} P ( x , y ) d y} . \qquad ( 8 )$$

The predicted ŷ maximizes this conditional probability ŷ=arg max_{u∈Y} P (y|x). Note that the term in the denominator of eq. (8) _{remains constant}, hence for the purposes of finding the optimum its evaluation may be ignored. This conditional is evaluated for the entire range of Y in discrete steps and the value of y ∈ Y that maximizes the conditional is picked.

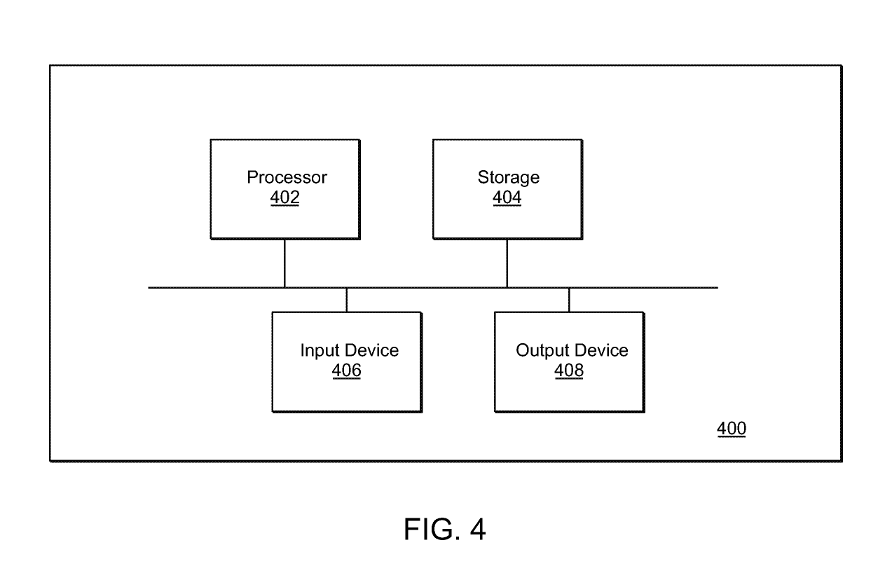

The wind resource assessment processes described above may be implemented in software, hardware, firmware, or any combination thereof. The processes are preferably implemented in one or more computer programs executing on a programmable computer system. FIG. 4 is a simplified drawing of such a computer system 400, which includes, among other components, at least one processor 402, a storage medium 404 readable by the processor 402 (including, e.g., volatile and non-volatile memory and/or storage elements), one or more input devices 406 (e.g., keyboard, mouse, or touchpad), and one or more output devices 408 (e.g., display). Each computer program can be a set of instructions (program code) in a code module resident in a random access memory of the computer system. Until required by the processor, the set of instructions may be stored in another computer memory (e.g., in a hard disk drive, or in a removable memory such as an optical disk, external hard drive, memory card, or flash drive) or stored on another computer system and downloaded via the Internet or other network.

In one or more embodiments, the computer system comprises a server computer system accessible over a network by users of the system. The computer system provides an end-to-end automated wind resource assessment as a service deployed on the web or cloud. In one or more alternate embodiments, the computer system comprises a personal computer operated by the user.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer system may comprise one or more physical machines, or virtual machines running on one or more physical machines. In addition, the computer system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method for performing a wind resource assessment of a potential wind farm site, comprising the steps, each performed by a computer system, of:
(a) receiving wind condition data measured at the potential wind farm site over a given short term and wind condition data measured at a plurality of sites geographically proximal to the potential wind farm site over a given long term that includes the given short term;
(b) synchronizing the wind condition data measured at the potential wind farm site with the wind condition data measured at the plurality of geographically proximal sites over the given short term to generate time-synchronized data sets;
(c) building multivariate Gaussian copula correlation models between the time-synchronized data sets; and
(d) using the multivariate Gaussian copula correlation models and the wind condition data measured at the plurality of geographically proximal sites over the given long term, excluding the given short term, to estimate long term wind conditions at the potential wind farm site, and expressing said estimated long term wind conditions as a set of probability distributions.

2. The method of claim 1, further comprising organizing the wind condition data into a plurality of bins, each representing a different wind direction, and wherein step (c) comprises building a directional model for each bin correlating wind directions measured at the potential wind farm site with simultaneous wind directions measured at the plurality of geographically proximal sites.

3. The method of claim 2, wherein step (c) further comprises for each directional bin, training a Gaussian copula correlation model correlating wind speeds at the potential wind farm site with simultaneous wind speeds measured at the plurality of geographically proximal sites.

4. The method of claim 1, wherein the probability distributions comprise a probability histogram expressing the mean and variance in the estimated wind speeds.

5. The method of claim 1, further comprising determining the feasibility of the potential wind farm site based on set of probability distributions.

6. The method of claim 1, further comprising performing data munging on the wind condition data received in (a).

7. The method of claim 1, wherein wind condition data includes data on wind speed and wind direction.

8. The method of claim 1, wherein the given short term comprises a period of 3 to 60 months.

9. The method of claim 1, wherein the given long term comprises a period of 1 to 20 years.

10. A computer system, comprising:
at least one processor;
memory associated with the at least one processor; and
a program supported in the memory for performing a wind resource assessment of a potential wind farm site, the program containing a plurality of instructions which, when executed by the at least one processor, cause the at least one processor to:
(a) receive wind condition data measured at the potential wind farm site over a given short term and wind condition data measured at a plurality of sites geographically proximal to the potential wind farm site over a given long term that includes the given short term;
(b) synchronize the wind condition data measured at the potential wind farm site with the wind condition data measured at the plurality of geographically proximal sites over the given short term to generate time-synchronized data sets;
(c) build multivariate Gaussian copula correlation models between the time-synchronized data sets; and
(d) use the multivariate Gaussian copula correlation models and the wind condition data measured at the plurality of geographically proximal sites over the given long term, excluding the given short term, to estimate long term wind conditions at the potential wind farm site, and express said estimated long term wind conditions as a set of probability distributions.

11. The system of claim 10, wherein the program further comprises instructions for organizing the wind condition data into a plurality of bins, each representing a different wind direction, and wherein (c) comprises building a directional model for each bin correlating wind directions measured at the potential wind farm site with simultaneous wind directions measured at the plurality of geographically proximal sites.

12. The system of claim 11, wherein (c) further comprises for each directional bin, training a Gaussian copula correlation model correlating wind speeds at the potential wind farm site with simultaneous wind speeds measured at the plurality of geographically proximal sites.

13. The system of claim 10, wherein the probability distributions comprise a probability histogram expressing the mean and variance in the estimated wind speeds.

14. The system of claim 10, wherein the program further comprises instructions for determining the feasibility of the potential wind farm site based on set of probability distributions.

15. The system of claim 10, wherein the program further comprises instructions for performing data munging on the wind condition data received in (a).

16. The system of claim 10, wherein wind condition data includes data on wind speed and wind direction.

17. The system of claim 10, wherein the given short term comprises a period of 3 to 60 months.

18. The system of claim 10, wherein the given long term comprises a period of 1 to 20 years.

19. The system of claim 10, wherein the computer system comprises a personal computer.

20. The system of claim 10, wherein the computer system comprises a server computer accessible by users over a computer network.

21. A computer program product for performing a wind resource assessment of a potential wind farm site, said computer program product residing on a non-transitory computer readable medium having a plurality of instructions stored thereon which, when executed by a computer processor, cause that computer processor to:
(a) receive wind condition data measured at the potential wind farm site over a given short term and wind condition data measured at a plurality of sites geographically proximal to the potential wind farm site over a given long term that includes the given short term;
(b) synchronize the wind condition data measured at the potential wind farm site with the wind condition data measured at the plurality of geographically proximal sites over the given short term to generate time-synchronized data sets;
(c) build multivariate Gaussian copula correlation models between the time-synchronized data sets; and
(d) use the multivariate Gaussian copula correlation models and the wind condition data measured at the plurality of geographically proximal sites over the given long term, excluding the given short term, to estimate long term wind conditions at the potential wind farm site, and express said estimated long term wind conditions as a set of probability distributions.
